(19) United States
(12) Patent Application Publication
(10) Pub. No.: US 2024/0030432 A1
(43) Pub. Date: Jan. 25, 2024

(54) POSITIVE ELECTRODE ACTIVE MATERIAL, POSITIVE ELECTRODE, LITHIUM ION BATTERY, AND METHOD FOR PRODUCING POSITIVE ELECTRODE ACTIVE MATERIAL

(71) Applicant: TOYOTA JIDOSHA KABUSHIKI KAISHA, Toyota-shi (JP)

(72) Inventor: Ryosuke OHSAWA, Okazaki-shi (JP)

(21) Appl. No.: 18/313,471

(22) Filed: May 8, 2023

(30) Foreign Application Priority Data
Jul. 21, 2022 (JP) 2022-116510

(51) Int. Cl. H01M 4/525; H01M 4/505; H01M 10/0525

(52) U.S. Cl. CPC H01M 4/525; H01M 4/505; H01M 10/0525; H01M 2004/028

(57) ABSTRACT

A positive electrode active material includes a secondary particle. The secondary particle includes a primary particle. The primary particle includes lithium-containing layered transition metal oxide. In a bright field image by transmission electron microscopy, a histogram of luminance of the primary particle has a peak. The peak has a half-value width of 39 or more.

### CROSS-REFERENCE TO RELATED APPLICATION

This application claims priority to Japanese Patent Application No. 2022-116510 filed on Jul. 21, 2022 incorporated herein by reference in its entirety.

### BACKGROUND

### 1. Technical Field

The present disclosure relates to a positive electrode active material, a positive electrode, a lithium ion battery, and a method for producing the positive electrode active material.

### 2. Description of Related Art

Japanese Unexamined Patent Application Publication No. 2017-191738 (JP 2017-191738 A) discloses a positive electrode active material particle having a core portion and a shell portion.

### SUMMARY

In a lithium ion battery (hereinafter can be abbreviated as a “battery”), a reduction in initial resistance is required. For example, a positive electrode active material (secondary particle) having a core-shell structure has been proposed. The core-shell structure includes a core portion and a shell portion. The shell portion covers the surface of the core portion. For example, since the shell portion contains a relatively large amount of a conductive component (for example, cobalt), the resistance is expected to be locally reduced on the surface of the secondary particle. However, there is room for improvement in the resistance of the entire secondary particle.

An object of the present disclosure is to reduce the initial resistance.

A technical configuration and effects of the present disclosure will be described below. However, an effect mechanism of the present specification includes speculation. The effect mechanism does not limit the technical scope of the present disclosure.

1. A positive electrode active material includes a secondary particle.

The secondary particle includes a primary particle.
The primary particle includes lithium-containing layered transition metal oxide.
In a bright field image by transmission electron microscopy, a histogram of luminance of the primary particle has a peak.
The peak has a half-value width of 39 or more.

Hereinafter, the “lithium-containing layered transition metal oxide” can be abbreviated as “LMO”.

FIG. 1 is a conceptual diagram illustrating a first example of the secondary particle.

A secondary particle 12 includes a plurality of primary particles 11. Each of the primary particles 11 includes the LMO. The LMO has a layered crystal structure. The layered crystal structure is formed by alternately stacking transition metal layers and lithium (Li) layers. The layered crystal structure has directionality. That is, the layered crystal structure has a first direction D1 and a second direction D2. The first direction D1 is a stacking direction. The second direction D2 is a direction orthogonal to the stacking direction. It is considered that Li⁺ enters and exits the crystal structure along the second direction D2. Usually, in the primary particle 11, the crystal structure tends to orient in one direction. The orientation of the crystal structure within the primary particle 11 can limit the entry and exit of Li⁺ into and from the secondary particle 12.

FIG. 2 is a conceptual diagram illustrating a second example of the secondary particle.

In the positive electrode active material according to “1”, in the primary particle 21, randomness is imparted to the directionality of the crystal structure. Due to the randomness in the directionality of the crystal structure in the primary particle 21, the location where Li⁺ can enter and exit in the entire secondary particle 22 (surface and inside) can be increased. As a result, a reduction in the resistance is expected

FIG. 3 is an explanatory diagram of a histogram of luminance.

The directionality of the crystal structure can be specified by transmission electron microscopy (TEM). By the TEM, a bright field (BF) image of a cross section of the primary particle is captured. Due to the analysis of the BF image, a histogram of luminance is created. The histogram is unimodal. A half-value width of the peak is specified. Hereinafter, the half-value width is also referred to as “half-value width of luminance”. It is considered that the crystal structure has random directionality as the half-value width of the luminance is large. According to the new findings disclosed in the present disclosure, when the half-value width of the luminance is 39 or more, the resistance is expected to be reduced.

2. In the positive electrode active material according to “1”, the half-value width may be, for example, 39 to 65.

When the half-value width of the luminance is 39 to 65, an improvement in the cycle characteristics is also expected in addition to the reduction in the initial resistance.

3. In the positive electrode active material according to “1” or “2”, the lithium-containing layered transition metal oxide may have, for example, a composition represented by the following formula (1).

Li₁₋ₐNiₓM₁₋ₓO₂ (1)

In the above formula (1),
x and a satisfy relationships of 0<x≤1 and −0.5≤a≤0.5, respectively.
M is at least one selected from the group consisting of Co, Mn, and Al.

4. A positive electrode includes the positive electrode active material according to any one of “1” to “3”.

5. A lithium ion battery includes the positive electrode according to “4”.

6. A method for producing a positive electrode active material includes the following (a) to (c).
(a) A first material is formed by subjecting a mixture of a transition metal hydroxide and a lithium compound to a heat treatment.
(b) A second material is formed by cooling the first material.
(c) A secondary particle is formed by crushing the second material.
   The secondary particle includes a primary particle.
   The primary particle includes lithium-containing layered transition metal oxide.
   In a bright field image by transmission electron microscopy, a histogram of luminance of the primary particle has a peak.
   The peak has a half-value width of 39 or more.

In the method according to “6”, various conditions can be adjusted such that the half-value width of the luminance is 39 or more.

7. In the method according to “6”, (b) may include adjusting a cooling rate such that the half-value width of the luminance is 39 or more.

According to the new findings disclosed in the present disclosure, the cooling rate after firing can be a factor having a large influence on the half-value width of the luminance. As a fired product is quenched, the half-value width tends to increase.

Hereinafter, embodiments of the present disclosure (hereinafter can be abbreviated as the “present embodiment”) and examples of the present disclosure (hereinafter can be abbreviated as the “present example”) will be described. However, the present embodiment and the present example do not limit the technical scope of the present disclosure. The present embodiment and the present example are illustrative in all respects. The present embodiment and the present example are not restrictive. The technical scope of the present disclosure includes all changes within the meaning and range equivalent to the description of the claims. For example, from the beginning, it is planned to extract an appropriate configuration from the present embodiment and the present example and combine them as appropriate.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing a first example of secondary particles;

FIG. 2 is a conceptual diagram illustrating a second example of secondary particles;

FIG. 3 is an explanatory diagram of a histogram of luminance;

FIG. 4 is a schematic flow chart of a process for producing a positive electrode active material according to the present embodiment; and

FIG. 5 is a conceptual diagram of a lithium ion battery according to the present embodiment.

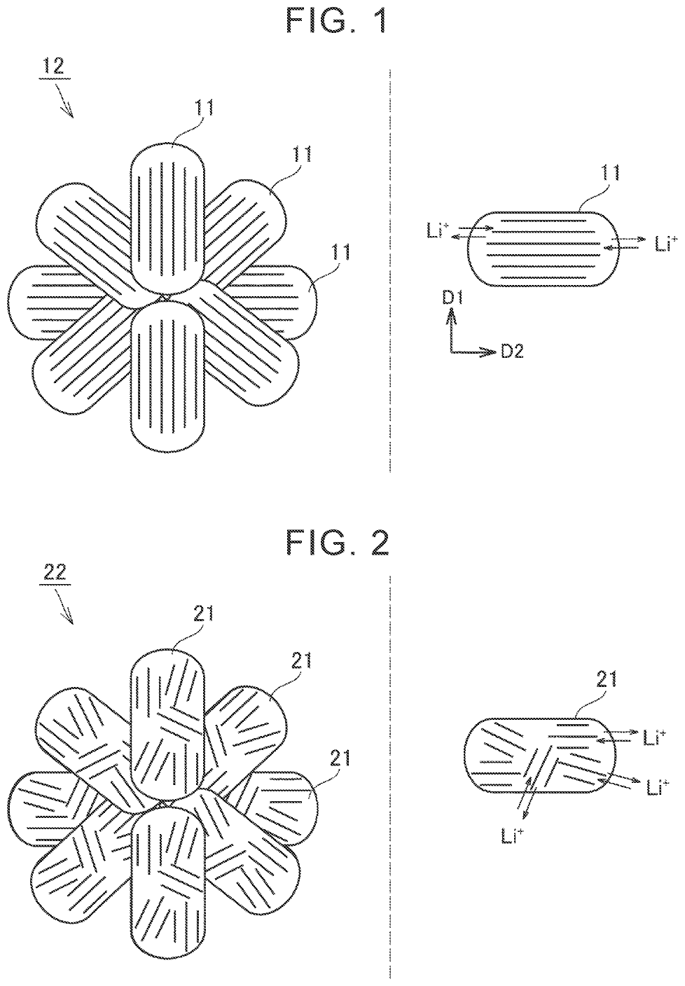

### DETAILED DESCRIPTION OF EMBODIMENTS

### Terms and Definitions, Etc.

Statements of “comprising,” “including,” and “having,” and variations thereof (for example “composed of”) are open-ended formats. The open-ended format may or may not include an additional element in addition to a required element. A statement of “consisting of” is a closed format. However, even when the statement is the closed format, normally associated impurities and additional elements irrelevant to the disclosed technique are not excluded. A statement “substantially consisting of” is a semi-closed format. The semi-closed format allows addition of an element that does not substantially affect the basic and novel characteristics of the disclosed technique.

Expressions such as “may” and “can” are used in the permissive sense of “having the possibility of” rather than in the obligatory sense of “must”.

An element expressed in a singular form also includes plural forms of elements unless otherwise specified. For example, a “particle” can mean not only “one particle” but also “a collection of particles (powder particles, powder, particle group)”.

For example, a numerical range such as “m % to n %” includes an upper limit value and a lower limit value. That is, “m % to n %” indicates a numerical range of “m % or more and n % or less”. In addition, “m % or more and n % or less” includes “more than m % and less than n %”. Further, a numerical value selected as appropriate from within the numerical range may be used as a new upper limit value or a new lower limit value. For example, a new numerical range may be set by appropriately combining numerical values within the numerical range with numerical values described in other parts of the present specification, tables, drawings, and the like.

For multiple steps, actions, operations, and the like included in various methods, the execution order thereof is not limited to the described order unless otherwise specified. For example, the multiple steps may proceed concurrently. For example, the multiple steps may occur one after the other.

All numerical values are modified by the term “approximately.” The term “approximately” can mean, for example, ±5%, 3%, 1%, and the like. All numerical values can be approximations that may vary depending on the mode of use of the disclosed technique. All numerical values can be displayed with significant digits. A measured value can be an average value of multiple measurements. The number of measurements may be three or more, five or more, or ten or more. In general, it is expected that the reliability of the average value improves as the number of measurements increases. The measured value can be rounded by rounding based on the number of significant digits. The measured value can include errors and the like associated with, for example, the detection limit of a measuring device.

When a compound is represented by a stoichiometric composition formula (for example, “LiCoO₂”), the stoichiometric composition formula is only a representative example of the compound. The compound may have a non-stoichiometric composition. For example, when lithium cobalt oxide is expressed as “LiCoO₂”, unless otherwise specified, the lithium cobalt oxide is not limited to a composition ratio of “Li/Co/O=1/1/2”, and can include Li, Co and O in any composition ratio. Further, doping with trace elements, substitution, etc. can also be permitted.

“D50” indicates a particle size in which the cumulative frequency from the smaller particle size reaches 50% in the volume-based particle size distribution. The particle size distribution can be measured by a laser diffraction particle size distribution measuring apparatus. The measurement sample can be prepared by dispersing the powder in water by sonication.

The “mean Feret diameter” is measured in two-dimensional images of the particles (e.g., a TEM image of the primary particles). The arithmetic mean of the largest ferret diameter in the 20 or more particles is the “average ferret diameter”.

“Hollow particle” refers to a secondary particle in which the area of the central cavity in the cross-sectional image is 30% or more of the total cross-sectional area of the particle. “Solid particles” refer to secondary particles in which the area of the central cavity in the cross-sectional image of the particles is less than 30% of the total cross-sectional area of the particles.

### Half-Value Width of Luminance

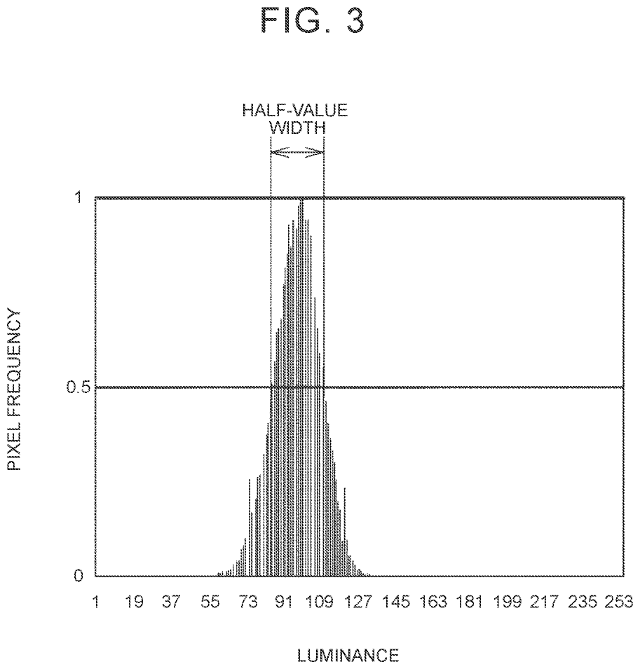

A “half-value width” indicates the full width at half maximum (FWHM). The “half-value width of luminance” is measured in the following procedure. A sample is produced by Focused Ion Beam (FIB) processing the secondary particles (positive electrode active material). A BF image of the sample is captured by TEM. The magnification of the image is 50000×. Image analysis software “ImageJFiji” cuts out an area consisting only of the primary particles from BF image. In this region, the luminance of each pixel is measured, thereby creating a histogram (see FIG. 3). The horizontal axis of the histogram is luminance. The vertical axis of the histogram is the pixel frequency. A unimodal peak appears in the histogram. The maximum value of the pixel frequency (peak vertex) is identified. The histogram of FIG. 3 is normalized such that the maximum value of the pixel frequency is 1. Two points of brightness are identified, where the pixel frequency is half of the maximum value (0.5 times). That is, in FIG. 3, two intersections of a straight line having a pixel frequency of 0.5 and a contour line of a peak are specified. The difference in luminance between the two points is regarded as a “half-value width”.

### Positive Electrode Active Material

The positive electrode active material is a powder material. The positive electrode active material includes secondary particles. The secondary particles may have a D50 of, for example, 1 μm to 30 μm, 1 μm to 20 μm, or 1 μm to 10 μm. The secondary particles include primary particles. The secondary particles are an aggregate of primary particles. The secondary particles may comprise, for example, 2 to 10000, 2 to 1000, or 2 to 100 primary particles. The primary particles may have an average Feret diameter of, for example, 0.01 μm to 3 μm, or 0.1 μm to 1 μm. The secondary particles may be solid particles or hollow particles.

The primary particles comprise LMO. The LMO has a layered crystal structure. LMO may have, for example, a layered rock salt-type construction. The crystallography of LMO may be attributed to the space group “R-3m”. Note that “-(bar)” in “R-3m” should be attached on “3” originally, but is attached in front of “3” for convenience.

Within the primary particles, the crystal structure has a random directionality. That is, the half-value width of the luminance is 39 or more. This is expected to reduce the initial resistance. The larger the half-value width of the luminance is, the lower the initial resistance is expected. The half-value width of the luminance may be, for example, 46 or more, 54 or more, or 65 or more.

When the directionality of the crystal structure is random to some extent, an improvement in cycle characteristics is also expected. This is thought to be due to the smooth entry and exit of Li. However, there is a possibility that the crystal structure becomes unstable as the directionality of the crystal structure becomes random. Instability of the crystal structure may also result in deterioration of the cycle characteristics. The half-value width of the luminance may be, for example, 80 or less, 65 or less, or 54 or less. The half-value width of the luminance may be, for example, 39 to 65. When the half-value width of the luminance is 39 to 65, an improvement in the cycle characteristics is also expected in addition to the reduction in the initial resistance. The half-value width of the luminance may be, for example, 39 to 54 or 54 to 65.

LMO may have, for example, a composition represented by the following formula (1).

Li₁₋ₐNiₓM₁₋ₓO₂ (1)

In the above formula (1), x and a satisfy the relationship of 0<x≤1, −0.5≤a≤0.5. M is, for example, at least one selected from the group consisting of Co, Mn and Al.

In Formula (1), x may be, for example, 0.1 or more, 0.2 or more, 0.3 or more, 0.4 or more, 0.5 or more, 0.6 or more, 0.7 or more, 0.8 or more, or 0.9 or more. x may be, for example, 0.9 or less, 0.8 or less, 0.7 or less, 0.6 or less, 0.5 or less, 0.4 or less, 0.3 or less, 0.2 or less, or 0.1 or less.

In the above formula (1), a may satisfy, for example, −0.4≤a≤0.4, −0.3≤a≤0.3, −0.2≤a≤0.2, or −0.1≤a≤0.1.

LMO may have, for example, a composition represented by the following formula (2).

Li₁₋ₐNiₓCo_{y}Mn_{1-x-y}O₂ (2)

In the above formula (2), x, y, z, a satisfies 0.5≤x<1, 0<y≤0.4, −0.5≤a≤0.5.

LMO may have, for example, a composition represented by the following formula (3).

Li₁₋ₐNiₓCo_{y}Al_{1-x-y}O₂ (3)

In the above formula (3), x, y, z, a satisfies 0.8≤x<1, 0<y≤0.2, −0.5≤a≤0.5.

LMO may comprise additives. The additive may be, for example, a substituted solid solution atom or an infiltrated solid solution atom. The additive may be a deposit that adheres to the face of LMO. The deposit may be, for example, a single substance, an oxide, a carbide, a nitride, a halide, or the like. The amount added may be, for example, 0.01 to 0.1, 0.02 to 0.08, or 0.04 to 0.06. The amount added indicates a ratio of the amount of the additive material to the amount of LMO material. The additive may include, for example, at least one selected from the group consisting of B, C, N, halogen, Sc, Ti, V, Cu, Zn, Ga, Ge, Se, Sr, Y, Zr, Nb, Mo, In, Sn, W, and lanthanoids.

### Method for Producing Positive Electrode Active Material

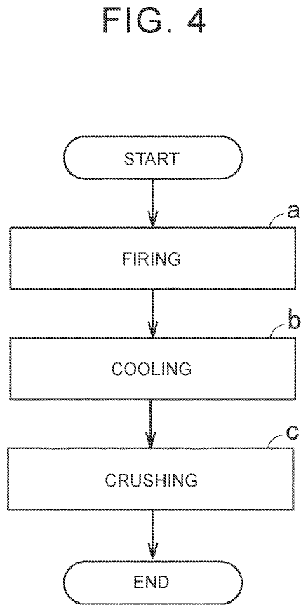

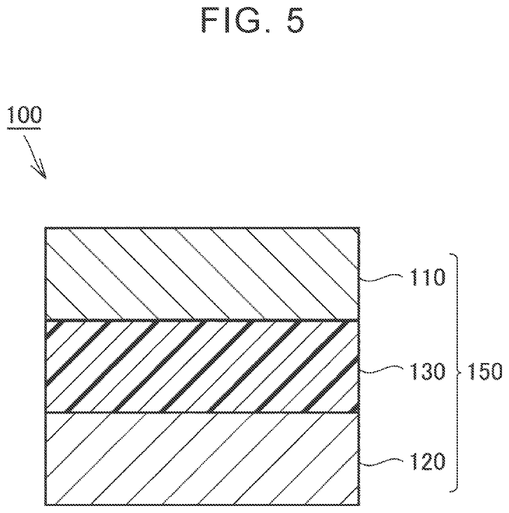

FIG. 4 is a schematic flowchart of a method for producing a positive electrode active material according to the present embodiment. Hereinafter, the method for producing a positive electrode active material according to the present embodiment may be abbreviated as “the present production method”. The manufacturing method includes “(a) calcination,” “(b) cooling,” and “(c) crushing.”

### (a) Firing

The process includes heat treating a mixture of a transition-metal hydroxide (hereinafter may be abbreviated as “MOH”) and a lithium compound to form a first material (calcined product).

MOH are precursors of LMO. MOH may be prepared in any manner. MOH may be synthesized, for example, by co-precipitation. For example, a source solution is prepared by dissolving a transition-metal sulfate (e.g., NiSO₄) in water. The raw material solution is added dropwise to the alkaline aqueous solution to form a reaction solution. The alkaline aqueous solution may contain, for example, NaOH or the like. By adjusting pH of the reactant, a precipitate (crystallized matter) of MOH can be formed. For example, pH of the reactant may be adjusted with ammonia-water or the like.

For example, MOH can be recovered by filtering the reactant. After recovery, MOH may be washed with water. After washing with water, MOH may be dried. The drying temperature may be, for example, 100° C. to 150° C. The drying time may be, for example, 8 to 24 hours.

Lithium compounds are Li sources of LMO. The lithium compound may include, for example, Li₂CO₃, LiOH. The process for mixing MOH with the lithium-compound is optional. For example, an attritor, a planetary ball mill, or the like may be used.

The heat treatment is also referred to as “firing”. By the heat treatment, LMO is formed and the crystallization of LMO can proceed. Any heat treatment furnace may be used in the present manufacturing method. For example, muffle furnaces, electric furnaces, etc. may be used. The treatment temperature (firing temperature) may be, for example, 600° C. to 1100° C., or 700° C. to 900° C. The treatment time (calcination time) may be, for example, 4 to 24 hours, or 6 to 12 hours.

### (b) Cooling

The method includes forming a second material by cooling the first material. The cooling method is optional. In the heat treatment furnace, the first material may be cooled by, for example, a cooling fan, a chiller, or the like. The first material is cooled to room temperature (25±10° C.). This may form a second material.

### (c) Crushing

The method includes crushing the second material to form secondary particles. Any crushing device may be used in the present manufacturing method. For example, a dry jet mill or the like may be used. The details of the secondary particles are as described above. The second material is crushed so that the secondary particles are of the desired size. After crushing, a classification process, a sizing process, and the like may be further performed.

As described above, the positive electrode active material can be produced. In the present manufacturing method, various conditions are combined so that the half-value width of the luminance is 39 or more. Factors that may affect the directionality of the crystalline structure include, for example, MOH composition, the mixing ratio (Li/M ratio) of MOH and the lithium compound, the firing conditions (temperature, duration), the cooling rate after firing, and the like.

For example, when the first material is quenched, the directionality of the crystal structure tends to become random. That is, the manufacturing method may include adjusting the cooling rate so that the half-value width of the luminance is 39 or more. The cooling rate of the first material may be, for example, greater than 10° C./min, greater than or equal to 12° C./min, greater than or equal to 33° C./min, or greater than or equal to 50° C./min. The cooling rate of the first material may be, for example, 100° C./min or less. It should be noted that the preferred range of cooling rate may change depending on, for example, the composition of MOH.

### A Lithium Ion Battery

FIG. 5 is a conceptual diagram of a lithium ion battery according to the present embodiment. Hereinafter, the “lithium ion battery in the present embodiment” may be abbreviated as “the present battery”. The battery 100 may be a liquid-based battery, a polymer battery, or an all-solid-state battery. That is, the battery 100 may include a liquid electrolyte, a gel electrolyte, or a solid electrolyte.

The battery 100 may include an exterior body (not shown). The outer casing may house the power generation element 150. The sheath may have any form. The outer casing may be, for example, a pouch made of a metal foil laminate film or a case made of metal. The case may be, for example, cylindrical or square.

The battery 100 includes a power generation element 150. The power generation element 150 includes a positive electrode 110, a separator 130, a negative electrode 120, and an electrolyte (not shown). The power generation element 150 may also be referred to as an electrode assembly, an electrode group, or the like. The power generation element 150 may be, for example, a stacked type or a wound type.

### Positive Electrode

The positive electrode 110 may have, for example, a sheet shape. The positive electrode 110 may include, for example, a positive electrode current collector and a positive electrode active material layer. The positive electrode current collector may include, for example, an Al foil. The positive electrode active material layer may be disposed on the surface of the positive electrode current collector. The positive electrode active material layer includes the aforementioned positive electrode active material. As long as the positive electrode 110 includes the aforementioned positive electrode active material, the positive electrode 110 may include an additional positive electrode active material. For example, the positive electrode active material layers may further include LiFePO₄. The positive electrode active material layer may further include a conductive material, a binder, and the like in addition to the positive electrode active material. The positive electrode active material layers may include, for example, acetylene black (AB), polyvinylidene fluoride (PVDF), and the like.

### Negative Electrode

The negative electrode 120 may have, for example, a sheet shape. The negative electrode 120 may include, for example, a negative electrode current collector and a negative electrode active material layer. The negative electrode current collector may include, for example, a Cu foil. The negative electrode active material layer may be disposed on the surface of the negative electrode current collector. The negative electrode active material layer includes a negative electrode active material. The negative electrode active material may be in a powder form or a sheet form. The negative electrode active material may include, for example, at least one selected from the group consisting of natural graphite, artificial graphite, soft carbon, hard carbon, Si, SiOₓ (0<x<2), Si based alloy, Sn, SnOₓ (0<x<2), Li, Li based alloy, and Li₄Ti₅O₁₂. The negative electrode active material layer may further include a conductive material, a binder, and the like. The negative electrode active material layers may include, for example, vapor-grown carbon fiber (VGCF), carboxymethyl cellulose (CMC), styrene-butadiene rubber (SBR), and the like.

### Separator

The separator 130 is interposed between the positive electrode 110 and the negative electrode 120. The separator 130 separates the positive electrode 110 from the negative electrode 120. In the case of a liquid-based battery, the separator 130 may include, for example, a porous sheet made of resin. In the case of an all-solid-state battery, the separator 130 may include, for example, a solid electrolyte layer or the like.

### Electrolyte

The electrolyte may form an ion conduction path. The liquid electrolyte includes, for example, a lithium salt and a solvent. The lithium-salt may include, for example, LiPF₆. Solvents may include, for example, ethylene carbonate (EC), dimethyl carbonate (DMC), ethyl methyl carbonate (EMC), and the like. The solid-state electrolyte may include, for example, a sulfide (Li₃PS₄, etc.).

### Preparation of Samples

As described below, the positive electrode active materials according to No. 1 to 5 were produced. Hereinafter, for example, the “positive electrode active material related to No. 1” or the like may be abbreviated as “No. 1”.

### No. 1

NiSO₄, CoSO₄, and MnSO₄ were dissolved in ion-exchanged water to form a raw material solution. In the raw material solutions, the atomic fraction of Ni, Co, Mn was “Ni/Co/Mn=1/1/1”. The solute concentration in the raw material solution was 30% (mass fraction).

Ammonia water was placed in the reaction vessel. The inside of the reaction vessel was replaced with nitrogen while the ammonia water was stirred by the stirrer. Further, an alkaline aqueous solution was formed by charging NaOH into the reactor vessel.

A precipitate of MOH was formed by dropping the raw material solutions and ammonia-water into the reaction vessel so that the reaction solution in the reaction vessel maintained a certain pH. MOH was recovered by filtering the reactant. MOH was dispersed in ion-exchanged water to form a dispersion. The dispersion was sufficiently stirred by the spatula. The dispersions were filtered to recover MOH. MOH was dried at 120° C. for 16 hours.

In the mortar, MOH and Li₂CO₃ were mixed. This formed a mixture.

### (a) Firing

The mixture was heat treated in a muffle furnace. The treatment temperature was 800° C. The treatment time was 8 hours. This formed the first material.

### (b) Cooling

In the muffle furnace, the first material was cooled to room temperature to form a second material. The cooling rate was 2° C./min.

### (c) Crushing

The positive electrode active material (secondary particles) was produced by crushing the second material by the jet mill. The positive electrode active material was composed of LiNi_{1/3}Co_{1/3}Mn_{1/3}O₂.

### No. 2 to 5

A positive electrode active material was produced in the same manner as No. 1 except that the cooling rate in “(b) cooling” was changed (see Tables 1 below).

### Evaluation

In the samples, the half-value width of brightness was measured by TEM method. The results are shown in Table 1 below.

Evaluation cells (hereinafter abbreviated as “cells”) were manufactured. The cell was a cylindrical lithium-ion battery. The cell configuration was as follows.
Positive electrode: positive electrode active material/AB/PVDF=88/10/2 (mass-ratio)
Negative electrode: negative electrode active material (natural graphite), CMC, SBR
Electrolyte: electrolyte “LiPF₆ (1 mol/L), EC/DMC/EMC=3/4/3 (volume)

The positive electrode and the negative electrode were manufactured by coating a slurry on the surface of a current collector (metal foil). As a coating apparatus, a film applicator (with a film thickness adjustment function) manufactured by All Good Co. was used. After coating the slurry, the coating was dried at 80° C. for 5 minutes.

In the next procedure, the initial resistance of the cell was measured. The cell voltage was adjusted to 3.7 V. The cells were discharged for 10 seconds with 1C current at room temperature. The initial resistance was obtained from the voltage drop amount and the current amount 10 seconds after the start of the discharge. The initial resistances in Table 1 below are relative values. The initial resistances in Tables 1 below are expressed as a percentage of the initial resistance of No. 1.

In the next procedure, the capacity retention after cycling of the cells was measured. The charge/discharge was repeated 200 times in 3.0 V to 4.1 V range by the constant current of 2C at room temperature. The capacity retention after cycling (percentage) was determined by dividing the 200th discharge capacity by the first discharge capacity. It is considered that the higher the capacity retention after cycling, the better the cycle characteristics.

TABLE 1

| | | | | TEM | | |
|---|---|---|---|---|---|---|
| | | | | imaging | | |
| | | | | analysis | | |
| | Production method | | | BF | Evaluation | |
| | | | (b) | image | | Capacity |
| | | | Cooling | Half-value | | retention |
| | (a) Firing | | Cooling | width of | Initial | after |
| | Temperature | Time | rate | luminance | resistance | cycling |
| | [° C.] | [h] | [° C./min] | [—] | [%] | [%] |
| 1 | 800 | 8 | 2 | 32 | 100 | 80 |
| 2 | 800 | 8 | 10 | 37 | 98 | 81 |
| 3 | 800 | 8 | 12 | 39 | 85 | 82 |
| 4 | 800 | 8 | 33 | 54 | 77 | 85 |
| 5 | 800 | 8 | 50 | 65 | 73 | 83 |

In Table 1, when the half-value width of the luminance is 39 or more, the initial resistance tends to decrease.

In Table 1, when the half-value width of the luminance is 39 to 65, the cycle characteristics tend to be improved.

What is claimed is:

1. A positive electrode active material comprising a secondary particle, wherein:
the secondary particle includes a primary particle;
the primary particle includes lithium-containing layered transition metal oxide;
in a bright field image by transmission electron microscopy, a histogram of luminance of the primary particle has a peak; and
the peak has a half-value width of 39 or more.

2. The positive electrode active material according to claim 1, wherein the half-value width is 39 to 65.

3. The positive electrode active material according to claim 1, wherein:
the lithium-containing layered transition metal oxide has a composition represented by the following formula (1): Li₁₋ₐNiₓM₁₋ₓO₂ . . . (1); and
in the above formula (1),
x and a satisfy relationships of 0<x≤1 and −0.5≤a≤0.5, respectively, and
M is at least one selected from the group consisting of Co, Mn, and Al.

4. A positive electrode comprising the positive electrode active material according to claim 1.

5. A lithium ion battery comprising the positive electrode according to claim 4.

6. A method for producing a positive electrode active material, comprising:
(a) forming a first material by subjecting a mixture of a transition metal hydroxide and a lithium compound to a heat treatment;
(b) forming a second material by cooling the first material; and
(c) forming a secondary particle by crushing the second material, wherein:
the secondary particle includes a primary particle;
the primary particle includes lithium-containing layered transition metal oxide;
in a bright field image by transmission electron microscopy, a histogram of luminance of the primary particle has a peak; and
the peak has a half-value width of 39 or more.

7. The method according to claim 6, wherein (b) includes adjusting a cooling rate such that the half-value width is 39 or more.
